(19) United States
(12) Patent Application Publication
(10) Pub. No.: US 2011/0042948 A1
(43) Pub. Date: Feb. 24, 2011

(54) DUMMY LOAD FOR A COMBINED HEAT AND POWER (CHP) SYSTEM

(75) Inventors: Paul R. Margiott, South Windsor, CT (US); Guangyan Zhu, Simsbury, CT (US)

Correspondence Address: Cantor Colburn LLP - Carrier, 20 Church Street, 22nd Floor, Hartford, CT, 06103, US

(73) Assignee: UTC POWER CORPORATION, South Windsor, CT (US)

(21) Appl. No.: 12/520,799

(22) PCT Filed: Dec. 22, 2006
(86) PCT No.: PCT/US06/48780

§ 371 Date: Jun. 22, 2009

(51) Int. Cl. F02C 6/18

(52) U.S. Cl. 290/2

(57) ABSTRACT

A method of operating a system for combined heat and power (CHP) includes generating electricity using a prime mover having a mechanical drive system. The method further includes distributing a variable amount of electricity from the prime mover to an electrical load and distributing a variable amount of electricity from the prime mover to a dummy load.

### BACKGROUND

The present disclosure relates to a combined heat and power system. More particularly, the present disclosure relates to using a dummy load in conjunction with a prime mover and a cogenerator of a combined heat and power system.

A combined heat and power (CHP) system, also known as on-site power generation, may produce electricity using a prime mover, while also providing heating and cooling through the use of waste heat recovered from the prime mover. Optimal operation of the CHP system may be impaired by a turndown capability of the prime mover, electrical load changes that require on and off cycling of the prime mover, and/or operating the prime mover at less than desired power to maintain zero power export. Moreover, in a typical CHP system, the cogenerator or heat recovery system relies upon exhaust from the prime mover, in order to provide heating and/or cooling. Thus, if the prime mover is operating at a lower power, due to a low electricity demand, a thermal output from the heat recovery system may consequently be low.

There is a need for a more efficient and optimized operation of the CHP system, which includes an ability to better handle load fluctuations in both an electrical load and a thermal load.

### SUMMARY

A method of operating a combined heat and power (CHP) system includes generating electricity using a prime mover that includes a mechanical drive system. The prime mover may include at least one of a reciprocating engine and a microturbine. The method further includes distributing a variable amount of electricity from the prime mover to an electrical load and distributing a variable amount of electricity from the prime mover to a dummy load.

### BRIEF DESCRIPTION OF THE DRAWINGS

FIG. 1 is a schematic of a combined heat and power (CHP) system, which includes a dummy load used with a prime mover.

FIG. 2 is a plot illustrating two operating scenarios for the CHP system of FIG. 1, with both scenarios including an electrical load and a thermal load.

FIG. 3 is a plot of electricity as a function of time to illustrate how the prime mover of FIG. 1 is impacted by changes to the electrical load if a dummy load is not included in the CHP system.

FIG. 4 is a plot illustrating the same electrical load shown in FIG. 3, but with a prime mover used in conjunction with a dummy load.

### DETAILED DESCRIPTION

As described herein, a dummy load may be used in a combined heat and power (CHP) system to improve operation of the CHP system. The dummy load may be used with a prime mover that is configured to generate electricity in the CHP system. The dummy load may receive electricity generated by the prime mover that is in excess of an amount required by a customer load. As such, the dummy load allows the prime mover to operate at a predetermined power, even as the customer load varies. (The predetermined power may be a maximum power for prime mover 12; in other cases, it may be a power rating that is less than maximum power.) Operation of the prime mover at or near maximum power may, in some cases, result in an increased overall efficiency of the CHP system. Alternatively, if the prime mover is turned down to a lower power rating, in response, for example, to a reduced customer load requirement, the dummy load may receive the excess electricity still being generated by the prime mover, since the turndown of the prime mover is not instantaneous. In this case, the dummy load may be used to prevent a power export to an electrical grid, as described in further detail below.

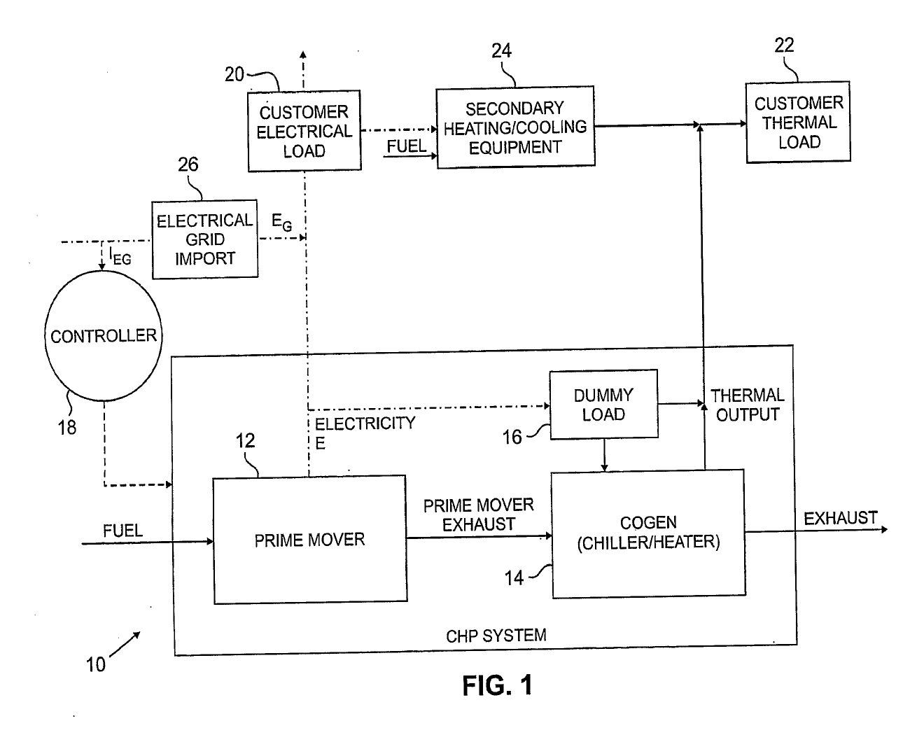

FIG. 1 is a schematic of combined heat and power (CHP) system 10, which includes prime mover 12, cogenerator 14, dummy load 16, and controller 18. System 10 may be used for any type of building, including commercial and residential buildings, and is well suited for power generation in a range of approximately 5 to 500 kilowatts of power.

Prime mover 12 may include any type of prime mover with a mechanical drive system, such as, but not limited to, a reciprocating engine and a microturbine. Moreover, prime mover 12 may represent multiple prime movers. As shown in FIG. 1, prime mover 12 is configured to receive fuel and generate electricity E, which may then be distributed to dummy load 16 and/or customer electrical load 20. The waste heat or exhaust from prime mover 12 may be used by cogenerator 14, which is a heat recovery system.

Cogenerator 14 is configured to provide a thermal output to customer thermal load 22, and it may function as a chiller and/or a heater depending on the particular needs of customer thermal load 22. Because cogenerator 14 relies on prime mover 12 for waste heat, a quantity of thermal output from cogenerator 14 is dependent on an operating power of prime mover 12. In addition to cogenerator 14, customer thermal load 22 may receive thermal output from secondary equipment 24 for heating and/or cooling, as shown in FIG. 1. As described in further detail below, customer thermal load 22 may also receive thermal energy from dummy load 16.

Customer electrical load 20 receives electricity E from prime mover 12, as well as electricity E_{G} from electrical grid 26. Electrical load 20 may include any electrical demands of the building where CHP system 10 is located. Electrical load 20 includes secondary equipment 24, which may include, for example, a furnace or a roof-top chiller. In some cases, the amount of electricity required by secondary equipment 24 may be insignificant. Under some conditions, a demand from electrical load 20 may be greater than a maximum output of prime mover 12, in which case electrical grid 26 may be used to supply electricity to customer electrical load 20. Moreover, electrical grid 26 may commonly supply a constant, minimal amount of electricity to customer electrical load 20. As described in more detail below, grid 26 may be used to help in preventing power export by prime mover 12, as fluctuations occur to electrical load 20.

Customer electrical load 20 may vary frequently, as the electrical demands of the building vary. Consequently, electricity E generated by prime mover 12 and electricity E_{G} imported from electrical grid 26 also must vary. Prime mover 12 may be limited in terms of how much it may vary an amount of electricity E generated; furthermore, these variances may, in some cases, reduce the operational life of prime mover 12 or reduce the operational efficiency of system 10. Finally, it is also important to prevent an export of electricity E from prime mover 12 (i.e. ‘zero power export’) to electrical grid 26, due to safety concerns.

Dummy load 16 is configured to receive a portion of electricity E from prime mover 12, in order to improve operation of prime mover 12 and system 10 overall. In an exemplary embodiment, dummy load 16 may be a resistive heater. However, it is recognized that dummy load 16 may include any type of device capable of receiving electricity and converting the electricity into thermal energy. As another example, dummy load 16 may include a rotating device, such as a fan. Dummy load 16 may include more than one piece of equipment. For example, in addition to including a resistive heater for heating, dummy load 16 may also include a piece of equipment configured for cooling. In that case, electricity E from prime mover 12 may be selectively distributed to the various equipment of dummy load 16, depending on the needs of customer thermal load 22.

Dummy load 16 is configured to receive excess electricity E from prime mover 12 resulting from changes to customer electrical load 20. Without dummy load 16 in system 10, prime mover 12 may commonly cycle on and off to accommodate fluctuations from customer electrical load 20 and to prevent power export. Moreover, without dummy load 16, prime mover 12 may commonly operate at a lower power rating, again to prevent a power export. In those cases in which prime mover 12 is turned down, for example in response to a reduced demand from customer electrical load 20, the reduction in electricity E from prime mover 12 is not instantaneous. There is a risk that excess electricity from prime mover 12 that is not required by load 20 may be exported to grid 26. Dummy load 16 is configured to address all of these potential limitations of system 10.

As shown in FIG. 1, dummy load 16 receives electricity E from prime mover 12 and generates a thermal output that may then be distributed to customer thermal load 22. Dummy load 16 may also be thermally coupled to cogenerator 14 and distribute a thermal output directly to cogenerator 14. The thermal output from dummy load 16 may be used in conjunction with waste heat from prime mover 12, such that cogenerator 14 is able to provide a greater amount of chilling to customer thermal load 20. For example, if cogenerator 14 includes a heat-driven chiller, thermal output (i.e. heat) from dummy load 16 may be used to heat a working fluid, such as lithium bromide, used for cooling.

Because dummy load 16 is able to generate thermal energy, using electricity E from prime mover 12, dummy load 16 improves the heating or cooling capabilities of CHP system 10. More specifically, use of dummy load 16 within system 10 improves operation of system 10 in those cases where a demand from customer thermal load 22 may be generally high or periodically increase, yet a demand from customer electrical load 20 may be relatively low.

Controller 18 is used to control operation of system 10. More specifically, controller 18 is configured to control an amount of electricity E generated by prime mover 12 and a distribution of electricity E from prime mover 12 to dummy load 16. Controller 18 also may control a distribution of thermal energy from dummy load 16 (i.e. directly to customer thermal load 22 or to cogenerator 14).

In the exemplary embodiment shown in FIG. 1, controller 18 receives input I_{EG} from electrical grid 26, which is an amount of electricity imported by customer electrical load 20 from electrical grid 26. By monitoring electricity E_{G}, controller 18 is able to monitor a demand of customer electrical load 20. Based on changes in the demand of load 20, controller 18 adjusts a power set point of controller 18 in order to increase or decrease the amount of electricity E generated by prime mover 12. For example, if controller 18 observes that electricity E_{G} imported from the grid is decreasing (i.e. input I_{EG}), this is an indication that customer electrical load 20 is decreasing. As a result, controller 18 may lower the power set point for prime mover 12 in order to decrease a power rating of prime mover 12. Decreasing the power rating of the prime mover is referred to as a “turn down” and results in a decrease in the amount of electricity E generated by prime mover 12.

Controller 18 also controls operation of dummy load 16 by turning dummy load 16 on and off, as needed, and adjusting a set point of dummy load 16 when dummy load 16 is on. For example, during an initial operation of system 10, dummy load 16 may not be turned on. However, if controller 18 decides to turn down prime mover 12, due to a decrease in electrical load 20, then controller 18 may turn on dummy load 16. Because the turn down of prime mover 12 is not instantaneous, dummy load 16 may be used during the turn down to receive excess electricity E from prime mover 12 that is not needed by load 20. As prime mover 12 is slowing down to the lower power rating, controller 18 may be decreasing the set point of dummy load 16. At some point (either when load 20 increases or when prime mover 12 is essentially generating an amount of electricity required by load 20), controller 18 may turn off dummy load 16.

Instead of turning down prime mover 12 when there is a decrease in load 20, controller 18 may maintain prime mover 12 at the current power rating and dummy load 16 may receive all excess electricity E produced by prime mover 12 that is in excess to a demand from load 20. In yet another embodiment of system 10, dummy load 16 may always be turned on during an operation of prime mover 12. In that case, controller 18 may vary the set point of dummy load 16 depending on fluctuations to electrical load 20, as well as demands from customer thermal load 22.

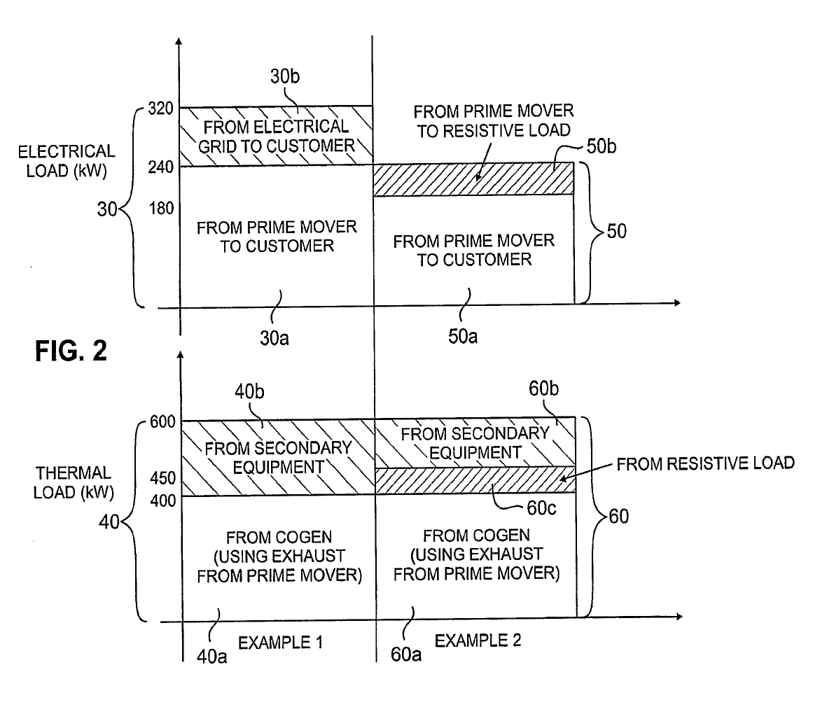

FIG. 2 is a plot illustrating two operating scenarios for CHP system 10 of FIG. 1. In both examples, system 10 has a demand from customer electrical load 20 and a demand from customer thermal load 22. In Example 1, total electrical load 30 from customer 20 is equal to 320 kW. At maximum power, prime mover 12 is able to generate 240 kW of electricity (designated as component 30a in FIG. 2). Because prime mover 12 is not able to produce any electricity beyond 240 kW, electric grid 26 imports 80 kW to customer electrical load 20 (designated as component 30b in FIG. 2). Continuing with Example 1, total thermal load 40 from customer 22 is equal to 600 kW. Cogenerator 14 provides 400 kW using exhaust heat from prime mover 12 (designated as component 40a in FIG. 2.) The remaining 200 kW demanded from load 22 is provided by secondary equipment 24 (designated as component 40b in FIG. 2).

In Example 2 of FIG. 2, total electrical load 50 from customer 20 is now equal to 180 kW. In this example, prime mover 12 continues to operate at maximum power and generates 240 kW. As such, prime mover 12 has generated 60 kW of power in excess to that required by customer 20. Thus, prime mover 12 distributes 180 kW of electricity to customer 20 (designated as component 50a in FIG. 2) and controller 18 turns on dummy load 16 so that the excess electricity may be received by dummy load 16 (designated as component 50b in FIG. 2). Total thermal load 60 in Example 2 is equal to 600 kW (same as Example 1). As in the case of Example 1, cogenerator 14 generates 400 kW (designated as component 60a in FIG. 2) towards thermal load 22. However, in Example 2, because dummy load 16 received 60 kW of electrical energy from prime mover 12, dummy load 16 contributes 50 kW (designated as component 60c in FIG. 2) to thermal load 22. Consequently, only 140 kW is required from secondary equipment 24 (designated as component 60b in FIG. 2). As illustrated by Example 2, dummy load 16 allows CHP system 10 to provide additional thermal energy to customer load 22.

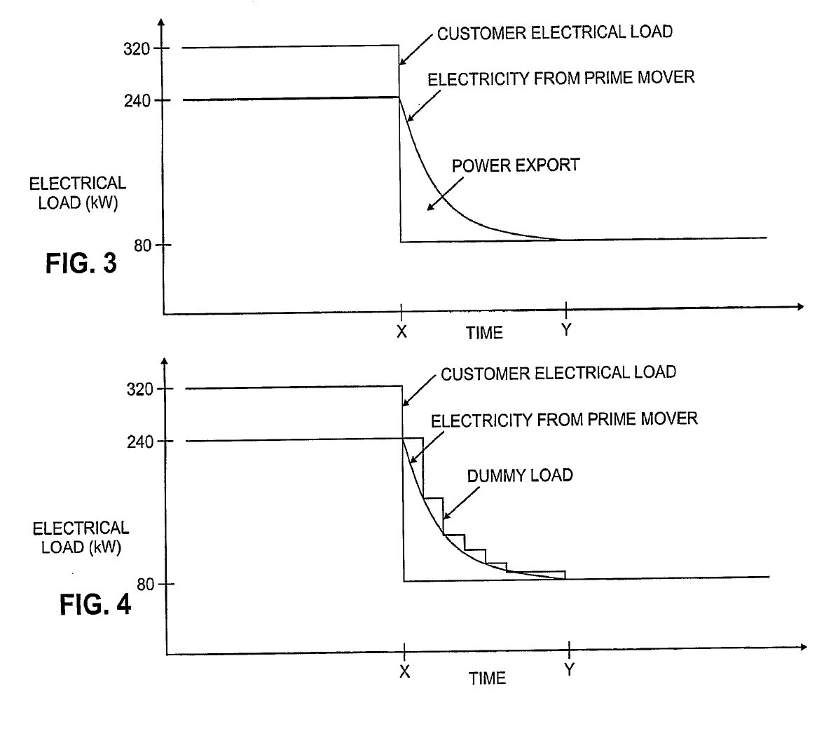

As described above and illustrated in FIG. 2, when customer electrical load 20 decreased from 320 kW (Example 1) to 180 kW (Example 2), prime mover 12 continued to operate at maximum power (240 kW). In that case, dummy load 16 received an amount of electricity from prime mover 12 (60 kW) that was in excess to what was demanded by customer electrical load 20. In another scenario, described below in reference to FIGS. 3 and 4, prime mover 12 may be turned down to a lower power rating when there is a decrease in electrical load 20.

FIG. 3 is a plot of electricity as a function of time to illustrate how prime mover 12 is impacted by changes to customer electrical load 20 if dummy load 16 is not included in CHP system 10. Customer electrical load 20 is originally demanding 320 kW of power. As stated above in reference to FIG. 2, in this exemplary embodiment, prime mover 12 is able to provide a maximum of 240 kW of power. Thus, in FIG. 3, customer electrical load 20 is receiving 80 kW of power from electrical grid 26. At time equal to X, a demand from customer electrical load 20 drops from 320 kW to 80 kW. Prime mover 12 may be turned down to accommodate the reduction in electrical load 20. In this case, a turndown ratio for prime mover 12 is equal to 3:1, since power is being turned down from 240 kW to 80 kW. However, as stated above, a turn down in power to prime mover 12 is not instantaneous. The time between X and Y is the time needed for prime mover 12 to turn down from a power rating of 240 kW to 80 kW. For the time period between X and Y, prime mover 12 is generating more than 80 kW of electricity, which is more than load 20 is demanding. The amount of electricity in excess of 80 kW (labeled power export in FIG. 3) is being exported to electrical grid 26. At time equal to Y, prime mover 12 is generating 80 kW of power, as demanded by electrical load 20, and power is no longer being exported to grid 26.

FIG. 4 illustrates the same scenario from FIG. 3 for customer electrical load 20. However, in contrast to FIG. 3, FIG. 4 illustrates the difference when dummy load 16 is used in conjunction with prime mover 12. As shown in FIG. 3, customer electrical load 20 decreases from 320 kW to 80 kW at time X. In this case, excess electricity (160 kW) from prime mover 12 that is no longer needed by electrical load 20 may be distributed to dummy load 16. Even with the use of dummy load 16, prime mover 12 may still be turned down, as described in reference to FIG. 3. As prime mover 12 slows down and generates less electricity, dummy load 16 receives less electricity from prime mover 12. This is shown in FIG. 4 by each step down in electricity to dummy load 16, which follows with the turn down of prime mover 12. In the case of FIG. 4, dummy load 16 is used to receive any excess electricity from prime mover 12; once prime mover 12 reaches a set point determined by customer electrical load 20, then dummy load 16 may be turned off.

Controller 18 of system 10 receives input I_{ES} from electrical grid 26, and uses the input to control prime mover 12 and dummy load 16. In FIGS. 3 and 4, the set point for prime mover 12 changed from 240 kW to 80 kW, in order to match the reduced electrical load 20 of 80 kW. However, even if the electrical load is 80 kW, controller 18 may actually have a set point for prime mover 12 that is less than 80 kW, since controller 18 may commonly maintain electrical grid 26 at a constant minimum value during operation of system 10. Even with the use of dummy load 16, it may be preferred to import a minimal amount of electricity from grid 26 during operation of system 10 as a safety factor.

Controller 18 observed a decrease in power imported from electrical grid 26 when electrical load 20 decreased from 240 kW to 80 kW, in the example shown in FIG. 4. In response to the decrease in imported power, controller 18 lowered the power set point of prime mover 12 and turned on dummy load 16. At some point after time Y, customer electrical load 20 may increase (not shown in FIG. 4). Controller 18 determines that there is an increased demand from load 20 because electrical grid 26 increases power to load 20. At that point, controller 18 may increase the power set point of prime mover 12 such that prime mover 12 operates at a higher power rating and generates an amount of electricity greater than 80 kW.

In the example of FIG. 4, the turndown ratio is 3:1. A turndown capability of prime mover 12 is dependent, in part, on the type of prime mover. For example, microturbines may commonly have better turndown capabilities as compared to a reciprocating engine. If the customer electrical load is reduced beyond the turndown limit of the prime mover, the dummy load may be used to receive the excess electricity generated by the prime mover.

Prime mover 12 is described above in reference to FIGS. 1 through 4 as a single prime mover. However, in other embodiments, CHP system 10 may include multiple prime movers. In the exemplary embodiment described above, prime mover 12 has a maximum power of 240 kW. It is recognized that prime mover 12 may alternatively be two prime movers, each with, for example, a maximum power of 120 kW. A benefit of multiple prime movers may be improved flexibility and efficiency in terms of meeting increased demands and larger fluctuations in the electrical load.

In an embodiment described in reference to FIG. 2, dummy toad 16 is used to receive any excess power from prime mover 12 if prime mover 12 is maintained at maximum power. In FIG. 3, dummy load 16 is used during a turn down of prime mover 12 from maximum power to a lower power rating. The use of a dummy load within the CHP system reduces on and off cycling of the prime mover(s), increased turndown capabilities, reduced risk of power export, and improved capabilities for heating and cooling. The dummy load provides greater flexibility to an operation of the CHP system, including an ability to adjust to changing demands from the electrical load and the thermal load.

The terminology used herein is for the purpose of description, not limitation. Although the present invention has been described with reference to preferred embodiments, workers skilled in the art will recognize that changes may be made in form and detail without departing from the spirit and scope of the invention.

1. A method of operating a system for combined heat and power (CHP), the method comprising:
generating electricity using a prime mover that includes a mechanical drive system;
distributing a variable amount of electricity from the prime mover to an electrical load; and
distributing a variable amount of electricity from the prime mover to a dummy load.

2. The method of claim 1 further comprising:
generating a thermal output with a cogenerator using waste heat from the prime mover.

3. The method of claim 2 wherein the thermal output is distributed to a thermal load.

4. The method of claim 1 further comprising:
controlling the amount of electricity distributed to the dummy load.

5. The method of claim 4 wherein controlling the amount of electricity to the dummy load is performed as a function of at least one of an amount of electricity required by the electrical load, an amount of electricity imported from an electrical grid, a turndown capability of the prime mover and an amount of thermal output required by a thermal load.

6. The method of claim 1 wherein the prime mover includes at least one of a reciprocating engine and a microturbine.

7. The method of claim 1 wherein the dummy load is a resistive heater.

8. The method of claim 1 wherein the dummy load is configured to generate a thermal output deliverable to at least one of a thermal load and a cogenerator configured for heat recovery.

9. A system for combined heat and power, the system comprising:
a prime mover having a mechanical drive system and configured to generate electricity deliverable to an electrical load;
a cogenerator thermally coupled to the prime mover, the cogenerator configured to utilize waste heat from the prime mover and generate a thermal output; and
a dummy load coupled to the prime mover, the dummy load configured to receive electricity from the prime mover.

10. The system of claim 9 wherein the prime mover includes at least one of a reciprocating engine and a microturbine.

11. The system of claim 9 wherein the thermal output is deliverable to a customer load to be used for at least one of heating and cooling.

12. The system of claim 9 further comprising:
a controller coupled to the prime mover and the dummy load, the controller configured to control distribution of electricity from the prime mover to the dummy load.

13. The system of claim 12 wherein distribution of electricity to the dummy load is controlled by the controller as a function of at least one of an amount of electricity required by the electrical load, an amount of electricity imported from an electrical grid, a turndown capability of the prime mover, and an amount of thermal output required by a thermal load.

14. The system of claim 12 wherein the controller is configured to control operation of the prime mover to vary an amount of electricity generated by the prime mover.

15. The system of claim 9 wherein the electrical load includes at least one piece of equipment configured to generate a thermal output.

16. The system of claim 9 wherein the dummy load is configured to generate a thermal output deliverable to a thermal load to be used for at least one of heating and cooling.

17. The system of claim 9 wherein the dummy load is thermally coupled to the cogenerator.

18. The system of claim 17 wherein the dummy load is configured to generate a thermal output deliverable to the cogenerator.

19. The system of claim 17 wherein the dummy load is configured to heat a working fluid in the cogenerator.

20. The system of claim 9 wherein the dummy load is a resistive heater.

21. A method of using a dummy load in a combined heat and power system, the method comprising:
generating electricity using a prime mover;
distributing electricity from the prime mover to an electrical load; and
controlling an amount of electricity distributed from the prime mover to a dummy load to prevent an export of electricity from the prime mover to an electrical grid.

22. The method of claim 21 further comprising:
generating a thermal output using the dummy load, wherein the thermal output is deliverable to at least one of a customer thermal load and a heat recovery system that uses waste heat from the prime mover.

23. The method of claim 22 wherein the thermal output may be used for at least one of heating and cooling.

24. The method of claim 22 wherein the dummy load is thermally coupled to the heat recovery system.

25. The method of claim 24 wherein the heat recovery system includes a chiller.

26. The method of claim 25 wherein the dummy load is configured to heat a working fluid of the chiller.

27. The method of claim 21 wherein the prime mover operates at a predetermined power and any electricity generated by the prime mover in excess of an amount required by the electrical load is distributed to the dummy load.

28. The method of claim 21 further comprising:
adjusting the prime mover from a predetermined power to a reduced power level as a function of a reduction in the electrical load, wherein electricity generated by the prime mover in excess of an amount required by the electrical load is distributed to the dummy load.
